(19) United States
(12) Patent Application Publication
(10) Pub. No.: US 2003/0023487 A1
(43) Pub. Date: Jan. 30, 2003

(54) Method and system for promotion

(76) Inventor: Adam S. Day, Minneapolis, MN (US)

Correspondence Address: Jonar J. Tolentino, DORSEY & WHITNEY LLP, Suite 1500, 50 South Sixth Street, Minneapolis, MN, 55402-1498, US

(21) Appl. No.: 10/156,697

(22) Filed: May 28, 2002

Related U.S. Application Data
(60) Provisional application No. 60/293,434, filed on May 25, 2001.

(51) Int. Cl. G06F 17/60; G06F 15/173

(52) U.S. Cl. 705/14; 709/223; 709/224

(57) ABSTRACT

The subject invention includes a promotional web site hosting a plurality of contests or promotions wherein prizes are awarded. A link to the web page in the promotional site featuring a specific contest or promotion are inserted into a plurality of media sponsor sites. The links are typically configured as symbols and are embedded within the media sponsor sites. Traditional media advertisement are then used to tie a contest or promotion to the indicant on the media sponsor site. Participants responding to the traditional media advertisement will look for the indicant in the media sponsor sites, and upon finding the indicant and selecting the indicant, the participant is linked to the promotional website. A registration process is then performed wherein the participant is asked to provide some personal information such as their name, email address, home address, and telephone number. Upon completion of this registration form, the participant then submits the registration form, and is then forwarded back to the same media sponsor site from which they came.

### CROSS-REFERENCE TO RELATED APPLICATION(S)

This application claims priority from U.S. provisional application No. 60/293,434, filed May 25, 2001, the contents of the provisional application are hereby incorporated herein in its entirety.

### TECHNICAL FIELD

The invention relates generally to a system and method for promoting an entity. More specifically, the invention relates to a method and system of promoting web sites in communication with a computer network.

### BACKGROUND OF THE INVENTION

A number of business entities have developed web sites located on the internet to provide advertising and marketing services to business entities seeking to provide products, services and information to their customers. However, it is often difficult to attract visitors to a web site. Potential visitors must first be made aware of the domain name of the web site and secondly, they must be coaxed into visiting the web site. This process is made more difficult with the large number of web sites competing for marketing and advertising revenue on the Internet.

Typically, a web site can justify the value of its advertising space by reaching a specific number of a targeted audience and holding that audience's attention. Consequently, in order to generate revenues a web site must demonstrate an ability to attract people. This ability to attract people is often measured in hits, page views, impressions and click throughs.

In order to promote a web site, business entities often use traditional media outlets such as print, radio, and TV. While these traditional methods of promotion may work for its intended purposes, they are often quite expensive to utilize. Furthermore, these methods are not assured of reaching the intended audience, most notably, people with a proclivity to transact on the internet.

Partly because of the above, businesses also often advertise their web sites on other web sites. Banner ads are typically used in a webv site to promote another web site. The banner ads typically include a graphic or message promoting a business entity and a hyperlink (“link”) to the ad's sponsor. While the banner ads are more proficient at reaching an audience with a proclivity to transact on the internet, the scope of interest in the web sit where it is displayed may be limited. Typically, a web site will not reach as large a segment of a community as the traditional media outlets.

Furthermore, even if traditional advertising and banner ads are successful in luring visitors onto a web site, initially, these methods typically do not create sufficient incentive for the potential visitor to thoroughly browse the contents of a web site. These forms of promotion also do not typically generate incentives for a visitor to revisit the web site.

Consequently, there is a need for a method and a system for increasing the value of a media internet web site which would provide an audience incentive to thoroughly browse through a web site and would provide incentives to visit and revisit a web site. A method and a system is needed which boosts the number of hits, page views, impressions, and click throughs in a web site thereby increasing the value of the web site.

There is also a need for a method and a system for aggregating promotional expense and reducing participation costs on a national and local level. Offering a larger prize nationally through local media allows local businesses and media to participate in promotions that have a greater incentive at a fraction of the promotional expense. In addition, national brands are now afforded an effective channel and opportunity to reach both the local media and internet audience.

### BRIEF SUMMARY OF THE INVENTION

Accordingly, the subject invention is a method and system for promoting goods or services. The subject invention includes a promotional web site hosting a plurality of contests or promotions wherein prizes are awarded. A link to the web page in the promotional site featuring a specific contest or promotion are inserted into a plurality of media sponsor sites. The links are typically configured as symbols and are embedded within the media sponsor sites. Traditional media advertisement are then used to tie a contest or promotion to the indicant on the media sponsor site.

In one embodiment, participants responding to the traditional media advertisement will look for the indicant in the media sponsor sites, and upon finding the indicant and selecting the indicant, the participant is linked to the promotional website. The promotional web site then directs the participant to a particular promotion or contest.

A registration process is then performed wherein the participant is asked to provide some personal information such as their name, email address, home address, and telephone number. Upon completion of this registration form, the participant then submits the registration form, and is then forwarded back to the same media sponsor site from which they came.

The subject invention enables advertisers who sponsor contests or promotions to gain exposure in a variety of different markets in a relatively inexpensive way. Also, the media sponsor sites also benefit in that they are able to offer their customers access to these contests, thereby providing incentives for their customers to link with and navigate their site.

### BRIEF DESCRIPTION OF THE DRAWINGS

FIG. 1 is a flow diagram of one embodiment of the subject promotion system.

FIG. 2 is a schematic diagram of a system configuration for one embodiment of the subject promotion system.

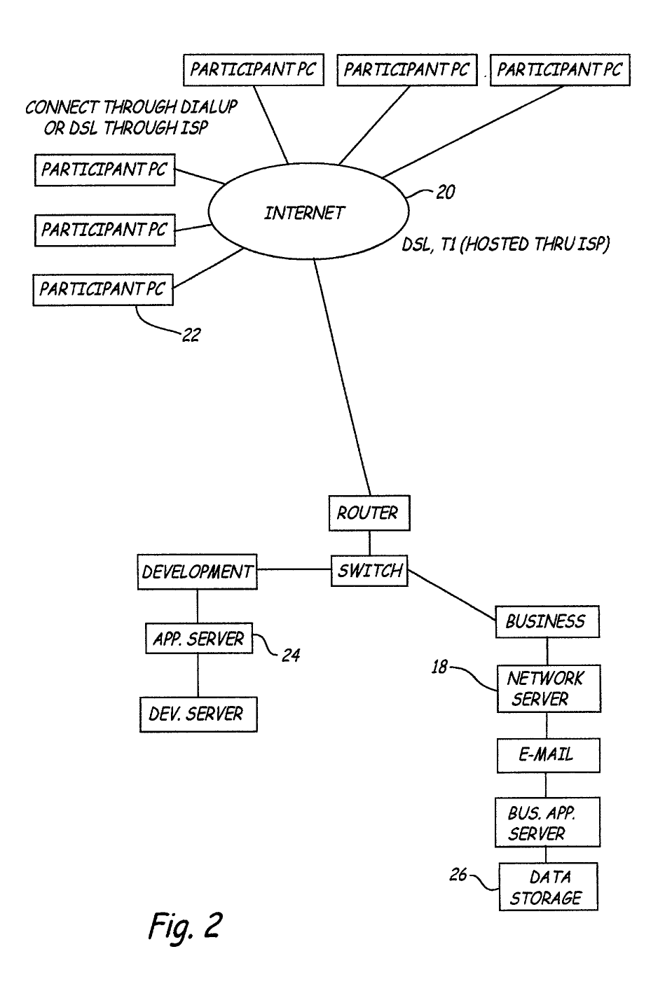

FIG. 3 is an embodiment of a schedule of promotions.

FIG. 4 is a flow diagram of the operation of the subject promotion system.

FIG. 5 is an embodiment of a registration form.

FIG. 6 is an embodiment of an additional questionnaire.

### DETAILED DESCRIPTION

General Overview

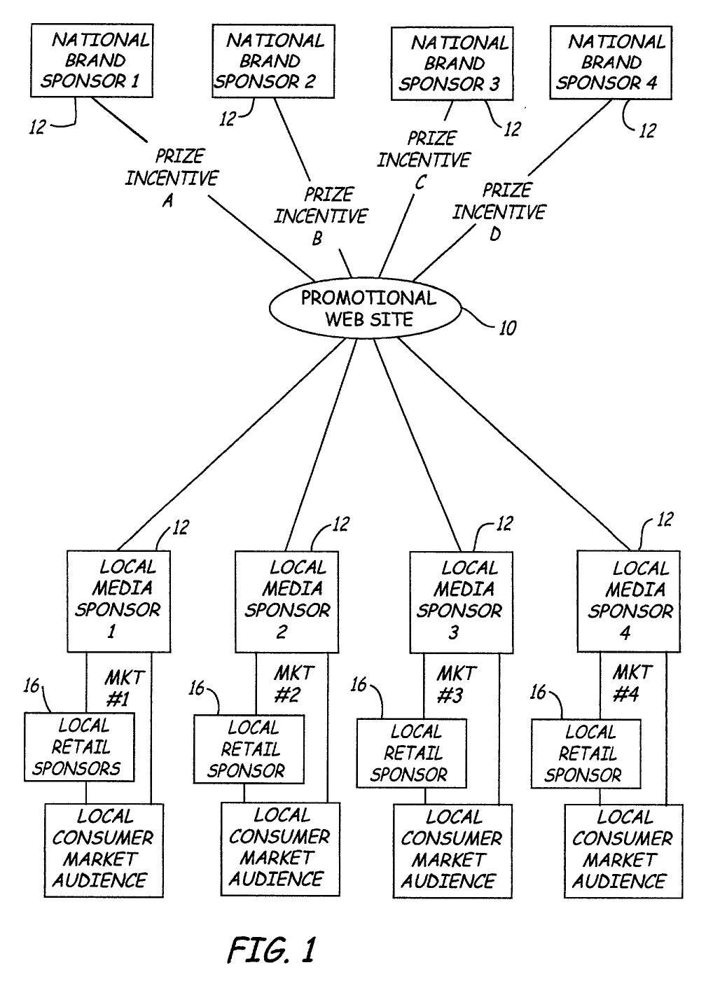

The subject invention is a method and system for promoting goods or services. As shown in FIG. 1, in one embodiment, a promotional web site 10 is created to promote a plurality of contests or promotions wherein prizes are awarded. A plurality of advertisers 12 obtain space in the promotional website to promote a contest or game wherein prizes are awarded. Participating media sponsor sites 14 either select from the various contests available on the promotional web site 10 or are assigned specific contests or promotions to host.

Links to the promotional site 10 are inserted into a plurality of media sponsor sites 14. The links direct a participant to a specific area of the promotional web site 10 wherein a specific contest or promotion is being hosted. Traditional media advertisement such as papers, television and radio within a locality are then used to promote a prize and ties that prize to an indicant located on the media sponsor site 14.

Participants responding to the traditional media advertisement will look for the indicant in the media sponsor sites 14. Clicking on the indicant will link the participant to the promotional site 10 and a contest for the advertised prize. Upon finding the indicant and selecting the indicant, the participant is linked to the promotional website 10. The promotional web site 10 then directs the participant to a particular promotion based on the URL of the media sponsor site 14.

A registration process is then performed wherein the participant is asked to provide some personal information such as their name, email address, home address, and telephone number. Upon completion of this registration form, the participant then submits the registration form, and is then forwarded back to the same media sponsor site 14 from which they came.

System Configuration

In one embodiment, the subject invention is implemented by the promotional web site 10 which includes at least one server 18 in communication with the Internet 20. The server 20 can be any computer known to those skilled in the art, including standard attachments and components thereof (e.g., a disk drive, hard drive, CD/DVD player or network server that communicates with a CPV and main memory, a sound board, a keyboard, mouse or printer). The server has therein a number of task-oriented applications.

In one embodiment, the promotional web site 10 includes includes a web server which hosts the promotional website. The web server utilizes the Internet 20 as a communications backbone and allows information to be passed to a browser located on the participant's computer 22. The web server may also include a form handler to collect and process information submitted by a participant through his browser. The promotional web site may also include an application server 24 for running a promotional applet across the Internet 20 onto the participant's computer 22.

Information communicated between the host site 10 and a participant's browser is typically achieved by the transmission of documents therebetween. These documents are commonly in Hyper Text Markup Language (HTML),but other languages such as DHTML, PEARL, XML, and WAP are also commonly used. Communication between the host site and the browser can also be achieved by other means using methods and computer languages which are generally known in the art.

In one embodiment, the host site includes a number of databases 26 which are utilized to store relevant information. These databases 26 are in communication with the host site, with information being exchanged therebetween.

Operation

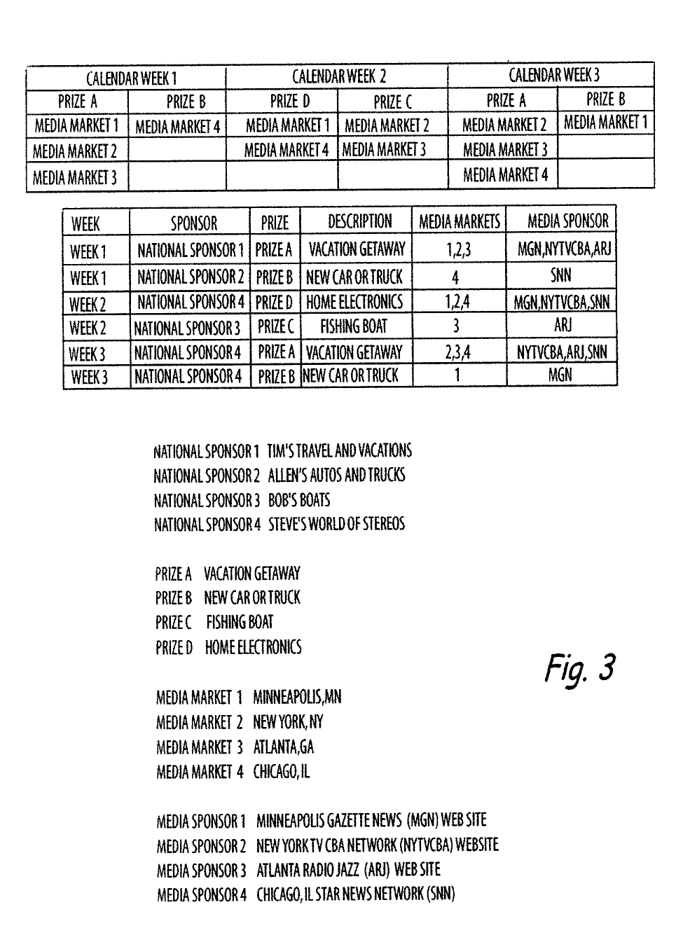

The promotional web site 10 promotes a plurality of contests or promotions wherein a prize is awarded. As shown in FIG. 3, in one embodiment, each contest or promotion being featured remains on the promotional web site for a contracted period of time. The advertisers 12 are allowed to target market areas or specific media sponsor sites 14 for each specific contest or promotion. Media sponsor sites 14 are then allowed to select from or are assigned access to specific contests or promotions on the promotional web site 10.

The media sponsor sites 14 are provided with links that direct a participant to a particular contest or promotion. In one embodiment, the links are displayed on a media sponsor site 14 as an indicant, wherein clicking the indicant links the participant to an area of the promotional web site hosting the predetermined contest or prize. Preferably, the indicant is a distinctive symbol. The link can also be displayed on the media sponsor site as a meta tag or an address.

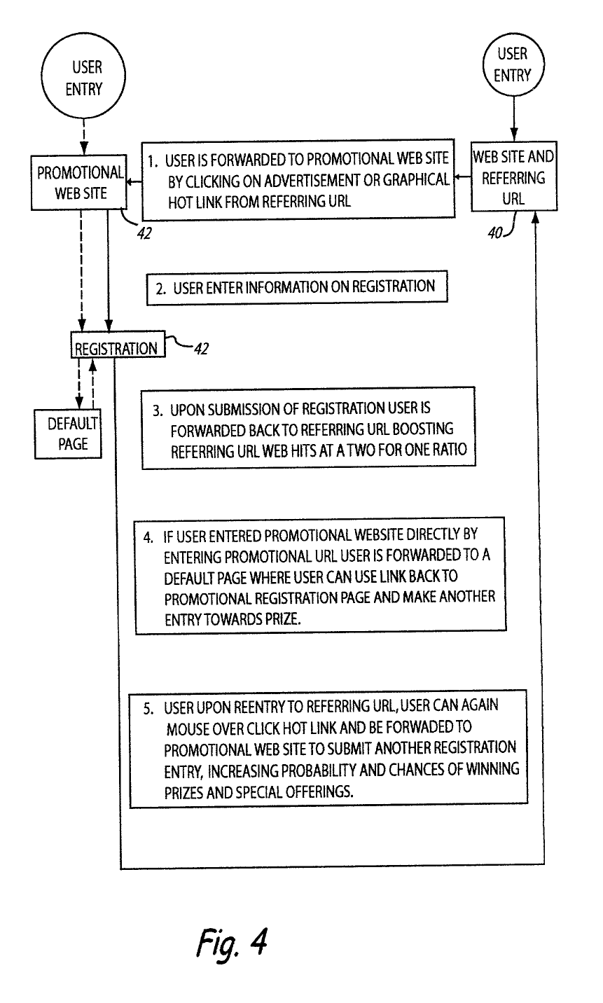

In one embodiment, advertisements in traditional media outlets are placed to promote a prize and to tie the prize to an indicant located in the local media sponsor 14 site. As shown in FIG. 4, participants responding to the traditional media advertisement are asked to look for an indicant in the media sponsor web site (box 40), and once found, to select the indicant and become linked to the promotional web site 10 (box 42).

Participants search the media sponsor site for the indicant forcing them to navigate through the web site. The search for an indicant increases the depth of navigation of the participant in the media sponsor site 14, and this in turn is very beneficial to the media sponsor site 14.

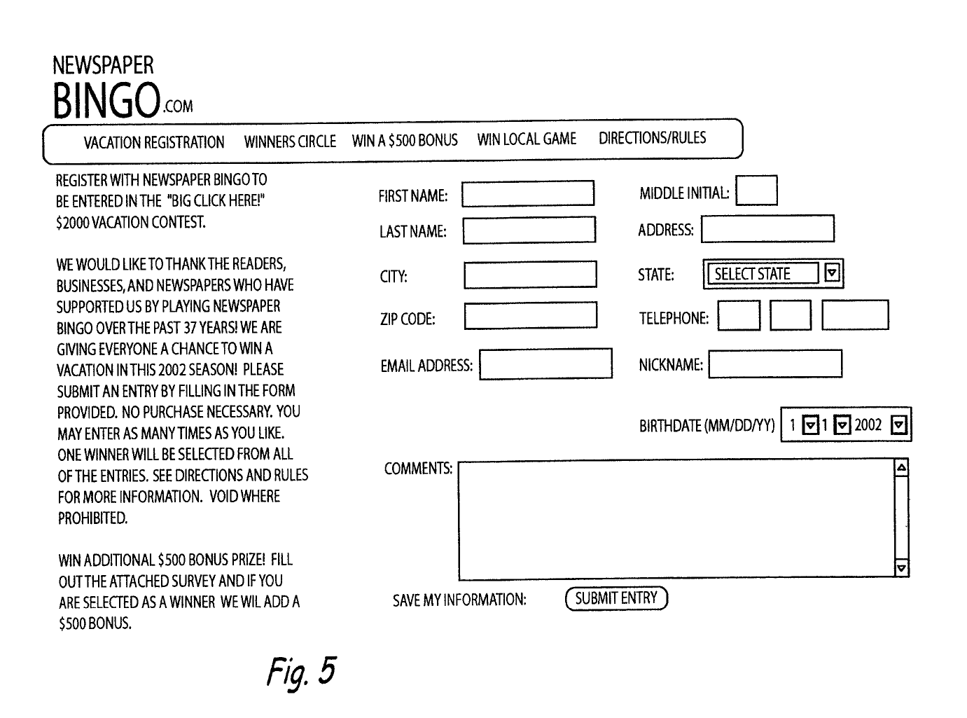

In one embodiment, clicking on the indicant, will first produce a web page requesting an E-mail address. Due to consumer sensitivity to providing information on the internet, the participant is first asked to provide an E-mail address prior to accessing the promotion or contest. Once the E-mail address is provided, the participant is provided a registration form (a sample of one type is shown in FIG. 5) for a contest or promotion (box 44). If a participant leaves the promotional site prior to completing a registration form. The E-mail address is forwarded to a lost registrant database, enabling future contact with the participant, if desired.

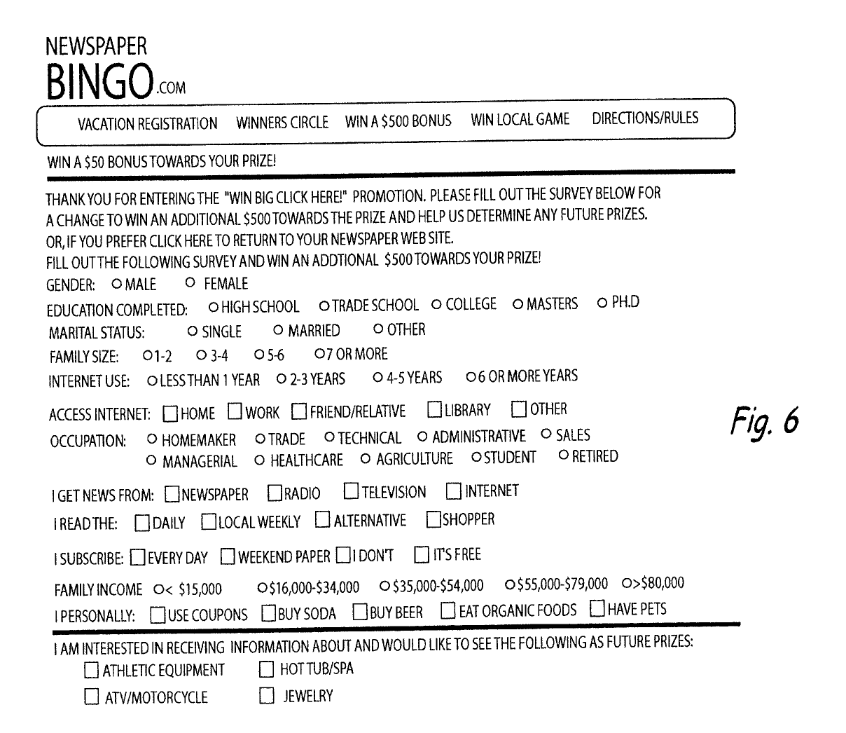

In one embodiment, upon completing the registration form, the participant is provided an additional opportunity to win additional prizes by answering a questionnaire and submitting it (a sample of one type is shown in FIG. 6). The questionnaire outlines specific interest profiles to help assist in the determination of future level of interest towards specific prizes, assist in the selection of future prize offerings and to gather demographic information on the participant. The information gathered is stored in a database and further analyzed for a variety of marketing related factors.

In one embodiment, data files containing user information (“cookies”) are deposited onto the participant's computer. If the participant returns to the promotional web site 10 at a later date, information in the cookies can also be used by the promotional web site 10 to direct the participant to a particular prize, or to prepare a completed registration form upon re-entry.

Upon submission of the information the participant is forwarded to the referring media sponsor site (box 40). This functionality promotes the referring media sponsor site 14 because the participant's return creates an additional hit for the media sponsor site 14. Once returned, the participant may continue to reenter the promotional web site to accumulate additional entries to a contest or promotion.

Promotional Management Interface

As shown in FIG. 3, in one embodiment, promotions or contests are scheduled weekly and are based on a 52 week period of the calendar year. Other time periods such as hourly, or daily, or monthly can also be utilized as promotional or contest periods. Using scheduling applications known in the art, the promotional web site 10 allows advertiser's 12 to go online to determine available periods of time wherein to schedule a contest or promotion on the promotional web site 10.

Specific geographical markets can be targeted by the advertisers 12 for each specific contest or promotion. Advertisers 12 can select specific target locations, or media sponsor sites 14, or select media sponsor sites located within a national, state, city, area, and zip code.

Media sponsor sites 14 are able to select specific contests or promotions enabling them to decide which prizes are available to their customers. Media sponsors 14 can also be assigned specific contests or promotions.

Although the present invention has been described with reference to preferred embodiments, persons skilled in the art will recognize that changes may be made in form and detail without departing from the spirit and scope of the invention.

I claim:

1. A method of promotion comprising:
providing a first site having a plurality of promotions hosted therein;
accepting a link from a participant at a second site to the first site;
determining a promotion for the participant based on the second site;
receiving information from the participant; and
forwarding the participant back to the second site.

2. The method of claim 1, and further comprising providing an indicant to the second site signaling the link to the first site.

3. The method of claim 2, and further comprising advertising the presence of the indicant in the second site.

4. The method of claim 3, and further comprising reading information on the participant's computer and inserting the participant information in the registration page.

5. The method of claim 4, wherein the step of determining a promotion is also based on participant information read from the participant's computer.

6. The method of claim 1 and wherein the promotion is a contest for a prize.

7. The method of claim 1, wherein the step of determining a contest includes determining the URL of the second site where the participant is linking from and directing the participant to a promotion based on the URL of the second site.

8. The method of claim 1, wherein the first site includes an interface for scheduling a promotion.

9. The method of claim 1, wherein the first site is a website in communication with a computer network.

10. The method of claim 8, wherein each second site is a web site in communication with a computer network.

11. A system for promotion comprising at least one server in communication with a computer network, the server hosting a website promoting a plurality of contests, the server also having applications therein to accept a link from a second site and to direct a participant to a particular contest based on the second site.

12. The system of claim 11, wherein the server includes an application for placing a cookie in a participant's computer.

13. The system of claim 11, wherein the server includes an application for extracting a cookie from a participant's computer.

14. The system of claim 13, wherein the server includes an application for extracting information from the cookie and using the information to direct a participant to a particular contest .

15. The system of claim 11, wherein the website includes a registration page for each contest.

16. A method of promotion comprising:
providing a first web site promoting a plurality of promotions therein;
providing an indicant to signal a link from a second web site to the first web site;
advertising an indicant located at the second web site; and
linking a participant from the second web site to a web page in the first web site based on the URL of the second web site.

17. The method of claim 16, and further comprising providing a registration form to the participant.

18. The method of claim 17, and further comprising providing a questionnaire to the participant.

19. The method of claim 16, and further comprising extracting a cookie from a participant's computer and using the information from the cookie to generate a completed registration form.

20. The method of claim 16, and further comprising forwarding the participant back to the second web site.
